(19) United States
(12) Patent Application Publication
(10) Pub. No.: US 2011/0246234 A1
(43) Pub. Date: Oct. 6, 2011

(54) PATIENT MATCHING

(75) Inventors: John Howard Irwin, Marcellus, NY (US); David Donald Gamble, East Syracuse, NY (US); James Kosecki, Syracuse, NY (US)

(73) Assignee: WELCH ALLYN, INC., Skaneateles Falls, NY (US)

(21) Appl. No.: 13/072,836

(22) Filed: Mar. 28, 2011

Related U.S. Application Data
(60) Provisional application No. 61/319,669, filed on Mar. 31, 2010.

(51) Int. Cl. G06Q 50/00; G06Q 10/00

(52) U.S. Cl. 705/3

(57) ABSTRACT

A method for matching patients in a list of patients includes uses a computing device to compare a first medical record to a second medical record using fuzzy logic. When the first medical record matches the second medical record based on the comparison using fuzzy logic, the first medical record is merged with the second medical record.

### RELATED APPLICATION

This application claims the benefit of U.S. Provisional Patent Application No. 61/319,669, filed Mar. 31, 2010, the entirety of which is hereby incorporated by reference.

### BACKGROUND

In a medical setting, it is important to correctly and unambiguously identify a patient who is being treated. Proper identification is essential to ensure that correct medical records are used and that the patient receives proper medication and medical treatment.

In a medical environment, patient information is often entered from multiple sources. In this environment, it is possible for information for the same patient to be entered multiple times and it is possible for multiple medical records to be created for the same patient.

### SUMMARY

Embodiments of the disclosure are directed to systems and methods for matching patients in a list of patients. In one aspect, using a computing device, a first medical record is compared to a second medical record using fuzzy logic. When the first medical record matches the second medical record based on the comparison using fuzzy logic, the first medical record is merged with the second medical record.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 is a block diagram illustrating an example system for collecting measurements of physiological parameters of patients.

FIG. 2 illustrates a view of an example physiological monitor device that can be used in the system illustrated in FIG. 1.

FIG. 3 illustrates an example user interface displayed on the display screen of the physiological monitor device of FIG. 2.

FIGS. 4 and 5 illustrate an example flowchart of a method for implementing fuzzy logic rules when adding or updating a medical record of a patient in the system of FIG. 1.

FIG. 6 illustrates example physical components of the physiological monitor device of FIG. 2.

### DETAILED DESCRIPTION

The present disclosure relates to patient matching algorithms used to reduce redundancy and identify patients more accurately.

In medical environments, patient information is often entered from multiple sources such as manual entry, a hospital information system (HIS), a patient management information system (PMIS) and an electronic medical records (EMR) system. Often patients are identified in different ways in each system and data is often incomplete and the entire patient data is scattered across the different data source. The algorithm attempts to harmonize and identify patients in order to reduce redundancy and increase accuracy of patient identification in the various workflows encounter in a medical environment.

This new algorithm applies fuzzy logic to help identify patients. Fuzzy logic is a system of logic that deals with partial truths rather than absolute truths. Fuzzy logic rules take into consideration multiple aspects of a variable before implementing an action based on the variable. For example, a temperature may be hot, normal, cold or very cold. For each of these conditions, a different action may be taken. Thus, a fan may be speeded up if the temperature is hot, the level of the fan may be maintained if the temperature is normal, the fan may be turned down if the temperature is cold and the fan may be stopped if the temperature is very cold.

Regarding the identification of a patient in a medical environment, using fuzzy logic, an assumption may be made regarding the identity patient when a complete identification for the patient is not provided. For example, a complete identification for a patient may comprise a medical record number (MRN), a date of birth (DOB), a gender and a legal name. The legal name typically includes at least a first name and a last name for the patient. Using fuzzy logic, identification for the patient may be made when only some of these identification items are known. Thus, when a DOB entry is missing or null, a match of the MRN may be sufficient to identify the patient.

In examples, fuzzy logic rules are used to determine whether to add a patient to a medical record database, to determine whether a record for the patient already exists in the medical record database and to update a medical record for a patient. In this disclosure, a medical record database may comprise any medical records system such as an HIS, PMIS and EMR system.

In examples, when determining whether to add a patient to a medical record database, a determination is first made as to whether a medical record for the patient already exists in the medical record database. In one example using fuzzy logic, in order to match a patient, there first must be an exact match of a MRN for the patient with a corresponding MRN in the medical record database. If only one such match is found, then it can be determined that a record for the patient already exists. Similarly, if no match is found for the MRN, then it can be determined that a medical record for the patient does not exist so that a new medical record can be created for the patient.

When multiple matches are found for the MRN, a much more extensive use of the fuzzy logic algorithm is required, as explained later herein. In general, however, these rules apply:
1. An MRN for a patient cannot be inserted as null or empty in the database.
2. In all matching rules, the MRN has to match exactly.
3. If an MRN is null or empty, the MRN does not match.
4. If a DOB is null or has an error value, the DOB is assumed to match. An error value is value for the DOB that evaluates to a nonsensical result, for example a DOB earlier than a predetermined minimum DOB. A DOB entered as 01/01/0001 is an example error value for the DOB. An example of a predetermined minimum DOB is 01/01/1900. Other types of error values are possible, for example a DOB later than the current date.
5. If gender is null or unknown, the gender is assumed to match.
6. If a last name entry is null or empty, the last name is assumed to match.

In examples, fuzzy logic rules may be set for various levels of filtering. For example, a rule may be in place to search the medical records database for matching records based on matching MRNs only. When there are no matches, a patient is added to the database.

As another example, a rule may be in place to first try and match patients based on their MRN. For this rule, if no match is found, the patient is added to the database. If a match is found, a consistency check is performed by matching the DOB and gender. The consistency check is explain in detail later herein.

As a third example, a rule may be in place to first try and match patients based on their MRN. For this rule, if no match is found, the patient is added to the database. If a match is found, a consistency check is performed by matching the DOB, gender and the last name of the patient's primary name. Other examples of fuzzy logic rules are possible.

In general, when adding a patient to a medical records database, these rules apply:

1. If there are no matches, the patient is added.

2. If there is one match (meaning two medical records are found for the patient) and the consistency check succeeds, a remapping of the patient to the found patient will occur. The remapping of the patient results in one or more of the matching records for the patient being deleted from the medical records database.

3. If there are more than one (>1) matches (meaning more than two medical records are found for the patient) or the consistency check fails, the patient is added, but each medical record for the patient is marked so that the redundant medical records for the patient can be manually reconciled.

In general when updating a medical record for a patient, the following rules apply:
1. Fuzzy logic rules are used only if any of the values in the element that participates in the system configured matching rules have changed. For example, fuzzy logic rules are used if a patient's name or DOB is updated.
2. If there are no conflicting matches, the patient is updated normally.
3. If there are one or more (>=1) matches to other patients, an exception is thrown. The exception indicates that a determination cannot be made from the rules as to how to reconcile the one or more matches to other patients. The exception indicates that a determination cannot be made from the rules as to how to reconcile the one or more matches to other patients.

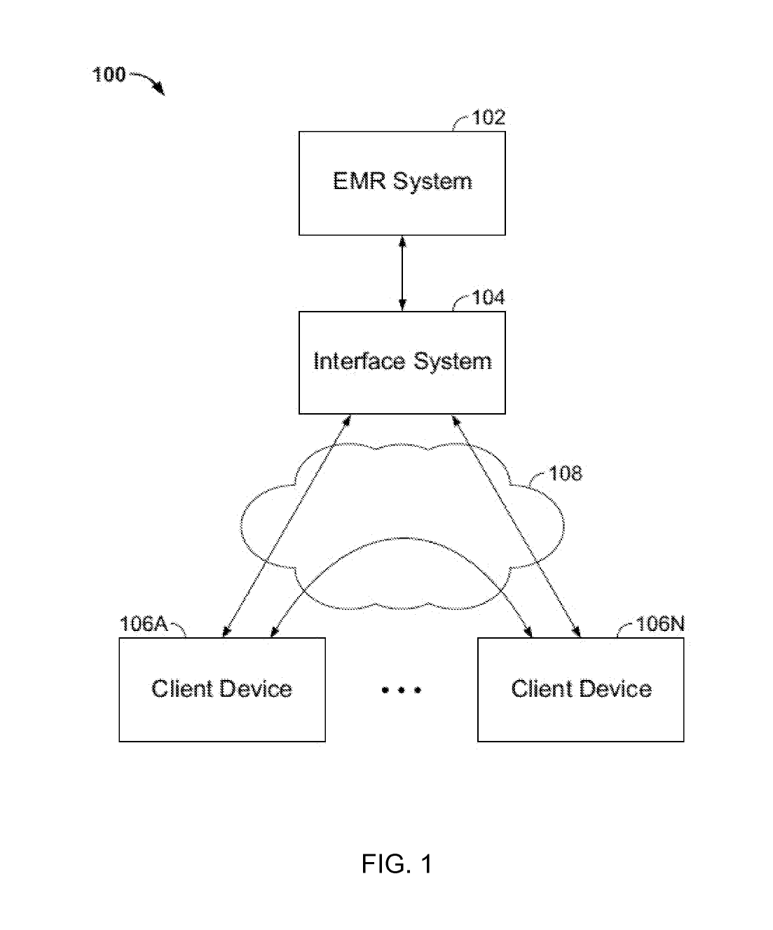

FIG. 1 is a block diagram illustrating an example system 100 for collecting measurements of physiological parameters of patients. As illustrated in the example of FIG. 1, the system 100 comprises an Electronic Medical Records (EMR) system 102, an interface system 104, a set of client devices 106A-106N (collectively, “client devices 106”), and a network 108.

The network 108 is an electronic communication network that facilitates communication between the client devices 106 and the between the client devices 106 and the interface system 104. An electronic communication network is a set of computing devices and links between the computing devices. The computing devices in the network use the links to enable communication among the computing devices in the network. The network 108 can include routers, switches, mobile access points, bridges, hubs, intrusion detection devices, storage devices, standalone server devices, blade server devices, sensors, desktop computers, firewall devices, laptop computers, handheld computers, mobile telephones, and other types of computing devices. In various embodiments, the network 108 includes various types of links. For example, the network 108 can include wired and/or wireless links. Furthermore, in various embodiments, the network 108 is implemented at various scales. For example, the network 108 can be implemented as one or more local area networks (LANs), metropolitan area networks, subnets, wide area networks (such as the Internet), or can be implemented at another scale.

The EMR system 102 is a computing system that allows storage, retrieval, and manipulation of electronic medical records. As used herein, a computing system is a system of one or more computing devices. A computing device is a physical, tangible device that processes data. Example types of computing devices include personal computers, standalone server computers, blade server computers, mainframe computers, handheld computers, smart phones, special purpose computing devices, and other types of devices that process data. In examples, the fuzzy logic algorithm is implemented on the EMR system 102.

Each client device in the set of client devices 106 is a computing device. The client devices 106 can provide various types of functionality. For example, the set of client devices 106 can include one or more physiological monitor devices (such as the physiological monitor device 200). In addition, the set of client devices 106 can include one or more desktop, laptop, or wall-mounted devices. Such wall-mounted devices can have similar functionality to the physiological monitor device 200 but are stationary instead of portable. In addition, the set of client devices 106 can include one or more physiological monitor devices. Such monitor devices can display representations of physiological parameters. A monitor device could, for example, be used by a clinician to monitor the physiological parameters of multiple patients at one time. Such monitor devices are typically not wall mounted.

The client devices 106 can communicate with each other through the network 108. In various embodiments, the client devices 106 can communicate various types of data with each other through the network 108. For example, in embodiments where the set of client devices 106 includes a set of physiological monitor devices and a monitor device, each of the physiological monitor devices can send data representing measurements of physiological parameters of patients to the monitor device. In this way, the monitor device can display representations of physiological parameters to a clinician.

The interface system 104 is a computing system that acts as an interface between the EMR system 102 and the client devices 106. In some embodiments, the interface system 104 is a CONNEX™ interface system from Welch Allyn of Skaneateles Falls, N.Y., although other interface systems can be used. Different EMR systems have different software interfaces.

For example, the EMR system used by two different hospitals can have two different software interfaces. The interface system 104 provides a single software interface to each of the client devices 106. The client devices 106 send requests to software interface provided by the interface system 104. When the interface system 104 receives a request from one of the client devices 106, the interface system 104 translates the request into a request that works with the software interface provided by the EMR system 102. The interface system 104 then provides the translated request to the software interface provided by the EMR system 102. When the interface system 104 receives a response from the EMR system 102, the interface system 104 translates the response from a format of the EMR system 102 to a system understood by the client devices 106. The interface system 104 then forwards the translated response to an appropriate one of the client devices 106.

The client devices 106 can send various types of data to the interface system 104 for storage in the EMR system 102 and can receive various types of data from the EMR system 102 through the interface system 104. For example, in some embodiments, the client devices 106 can send measurements of physiological parameters to the interface system 104 for storage in the EMR system 102. In another example, a monitor device can retrieve past measurements of physiological parameters of patients from the EMR system 102 through the interface system 104.

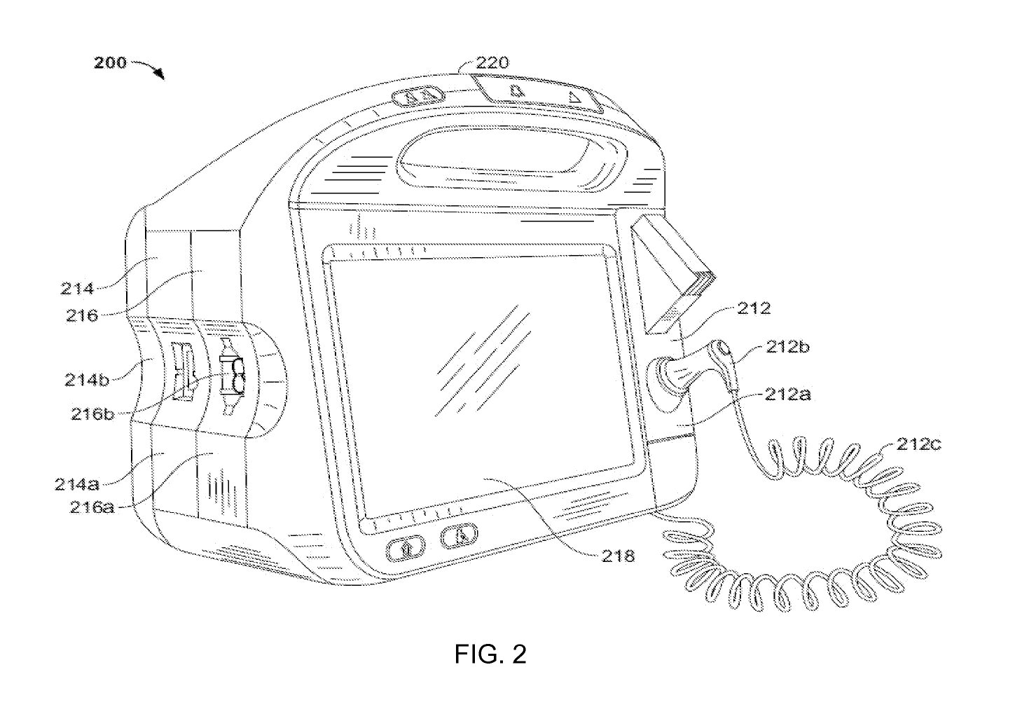

FIG. 2 illustrates a view of an example physiological monitor device 200. The physiological monitor device 200 is portable. The physiological monitor device 200 includes multiple health care equipment (HCE) modules. Each of the HCE modules is configured to measure one or more physiological parameters of a health-care recipient, also referred to herein as a patient.

A temperature measurement module 212 is accessible from the front side of the physiological monitor device 200. A SpO2 module 214 and a non-invasive blood pressure (NIBP) module 216 are accessible from a left hand side of the physiological monitor device 200. An upper handle portion 220 enables the physiological monitor device 200 to be carried by hand.

A front side of the physiological monitor device 200 includes a display screen 218 and an outer surface of the temperature measurement module 212. The temperature measurement module 212 is designed to measure the body temperature of a patient. As used in this document, a “module” is a combination of a physical module structure which typically resides within the physiological monitor device 200 and optional peripheral components (not shown) that typically attach to and reside outside of the physiological monitor device 200.

The temperature measurement module 212 includes a front panel 212a. The front panel 212a has an outer surface that is accessible from the front side of the physiological monitor device 200. The front panel 212a provides access to a wall (not shown) storing a removable probe (not shown), also referred to as a temperature probe, that is attached to a probe handle 212b. The probe and its attached probe handle 212b are tethered to the temperature measurement module 212 via an insulated conductor 212c. The probe is designed to make physical contact with a patient in order to sense a body temperature of the patient.

A left hand side of the physiological monitor device 200 includes an outer surface of the SpO2 module 214 and an outer surface of the NIBP module 216. The SpO2 module 214 is a HCE module designed to measure oxygen content within the blood of a patient. The NIBP module 216 is a HCE module designed to measure blood pressure of a patient.

As shown, the SpO2 module 214 includes a front panel 214a. The front panel 214a includes an outer surface that is accessible from the left side of the physiological monitor device 200. The front panel 214a includes a connector 214b that enables a connection between one or more peripheral SpO2 components (not shown) and a portion of the SpO2 module 214 residing inside the physiological monitor device 200. The peripheral SpO2 components reside external to the physiological monitor device 200. The peripheral SpO2 components are configured to interoperate with the SpO2 module 214 when connected to the SpO2 module 214 via the connector 214b. In some embodiments, the peripheral SpO2 components include a clip that attaches to an appendage of a patient, such as a finger. The clip is designed to detect and measure a pulse and an oxygen content of blood flowing within the patient.

As shown, the NIBP module 216 includes a front panel 216a having an outer surface that is accessible from the left side of the physiological monitor device 200. The front panel 216a includes a connector 216b that enables a connection between one or more peripheral NIBP components (not shown) and a portion of the NIBP module 216 residing inside the physiological monitor device 200. The peripheral NIBP components reside external to the physiological monitor device 200. The peripheral NIBP components are configured to interoperate with the NIBP module 216 when connected to the NIBP module 216 via the connector 216b. In some embodiments, the peripheral NIBP components include an inflatable cuff that attaches to an appendage of a patient, such as an upper arm of the patient. The inflatable cuff is designed to measure the systolic and diastolic blood pressure of the patient, the mean arterial pressure (MAP) of the patient, and the pulse rate of blood flowing within the patient.

The physiological monitor device 200 is able to operate within one or more workflows. A workflow is a series of one or more tasks that a user of the physiological monitor device 200 performs. When the physiological monitor device 200 operates within a workflow, the physiological monitor device 200 provides functionality suitable for assisting the user in performing the workflow. When the physiological monitor device 200 operates within different workflows, the physiological monitor device 200 provides different functionality.

When the physiological monitor device 200 is manufactured, the physiological monitor device 200 is configured to be able to operate within one or more workflows. After the physiological monitor device 200 is manufactured, the physiological monitor device 200 can be reconfigured to operate within one or more additional workflows. In this way, a user can adapt the physiological monitor device 200 for use in different workflows as needed.

In various embodiments, the physiological monitor device 200 operates within various workflows. For example, in some embodiments, the physiological monitor device 200 can operate within a monitoring workflow or a non-monitoring workflow. Example types of non-monitoring workflows include, but are not limited to, a spot check workflow and a triage workflow.

In example embodiments, the names for the workflows can be defined by the user. For example, the user can rename a “triage workflow” as “ED 3 North” or any other nomenclature as desired to provide more context to the user.

When the physiological monitor device 200 is operating within the monitoring workflow, the physiological monitor device 200 obtains a series of measurements of one or more physiological parameters of a single monitored patient over a period of time. In addition, the physiological monitor device 200 displays, on the display screen 218, a monitoring workflow home screen. The monitoring workflow home screen contains a representation of a physiological parameter of the monitored patient. The representation is based on at least one measurement in the series of measurements. A representation of a physiological parameter is a visible image conveying information about the physiological parameter.

For example, when the physiological monitor device 200 is operating within the monitoring workflow, the physiological monitor device 200 can obtain a blood pressure measurement of a single patient once every ten minutes for six hours. In this example, the physiological monitor device 200 displays a monitoring workflow home screen that contains a representation of the patient's blood pressure based on a most recent one of the temperature measurements. In this way, a user of the physiological monitor device 200 can monitor the status of the patient.

When the physiological monitor device 200 is operating within a non-monitoring workflow, the physiological monitor device 200 obtains a measurement of one or more physiological parameters from each patient in a series of patients. In addition, the physiological monitor device 200 displays a non-monitoring workflow home screen on the display screen 218. The non-monitoring workflow home screen contains a representation of the physiological parameter of a given patient in the series of patients. The representation is based on the measurement of the physiological parameter of the given patient.

In one example, when the physiological monitor device 200 is operating within a spot check workflow, the physiological monitor device 200 obtains blood pressure measurements from a series of previously-identified patients. In this other example, the physiological monitor device 200 displays a spot check workflow home screen containing a blood pressure measurement of a given patient in the series of previously-identified patients. In this way, a user of the physiological monitor device 200 can perform spot checks on the blood pressures of patients who have already been admitted to a hospital.

As used in this document, a patient is a previously identified patient when the physiological monitor device 200 stores information regarding the identity of the patient. In another example, when the physiological monitor device 200 is operating within a triage workflow, the physiological monitor device 200 can obtain a single blood pressure measurement from each patient in a series of unidentified patients as the patients arrive at a hospital. In this example, the physiological monitor device 200 displays a triage workflow home screen containing a representation of the patients' blood pressure based on the single blood pressure measurements of the patients. In this way, a user of the physiological monitor device 200 can perform triage on the series of unidentified patients as they arrive. As used in this document, a patient is an unidentified patient when the physiological monitor device 200 does not store information regarding the identity of the patient.

The monitoring workflow home screen is different than the non-monitoring workflow home screen. Further, as discussed below, the navigation options associated with the different workflows allows for efficient monitoring based on the environment in which the device is used. In various embodiments, the monitoring workflow home screen is different than the non-monitoring workflow home screen in various ways. For example, in some embodiments, the monitoring workflow home screen includes at least one user-selectable control that is not included in the non-monitoring workflow home screen. In other embodiments, a representation of a physiological parameter in the monitoring workflow home screen has a different size than a representation of the same physiological parameter in the non-monitoring workflow home screen.

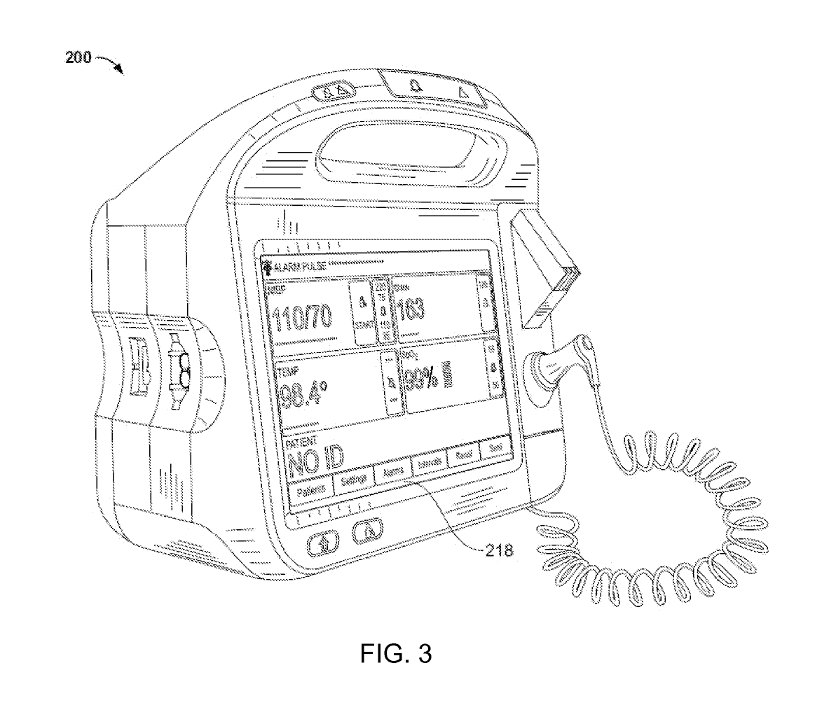

FIG. 3 illustrates an example user interface displayed on the display screen 218 of FIG. 2. The physiological monitor device 200 outputs and displays user interfaces discussed in this document on the display screen 218.

In some examples described herein, the physiological monitor device is a portable device. In other examples, the physiological monitor device is a non-portable device, such as a computing device like a workstation. Many configurations are possible.

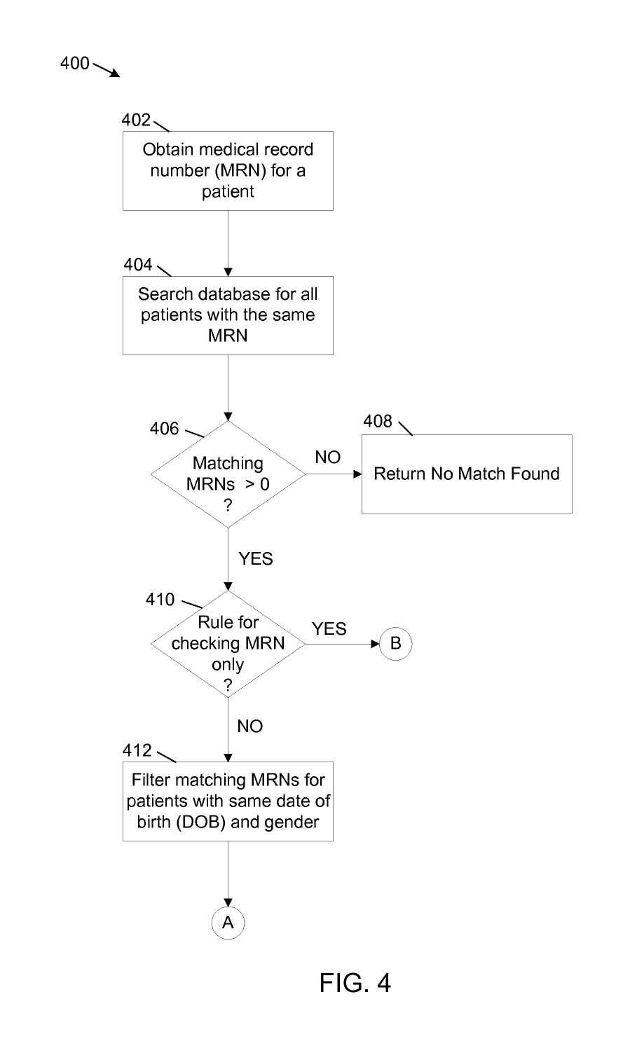

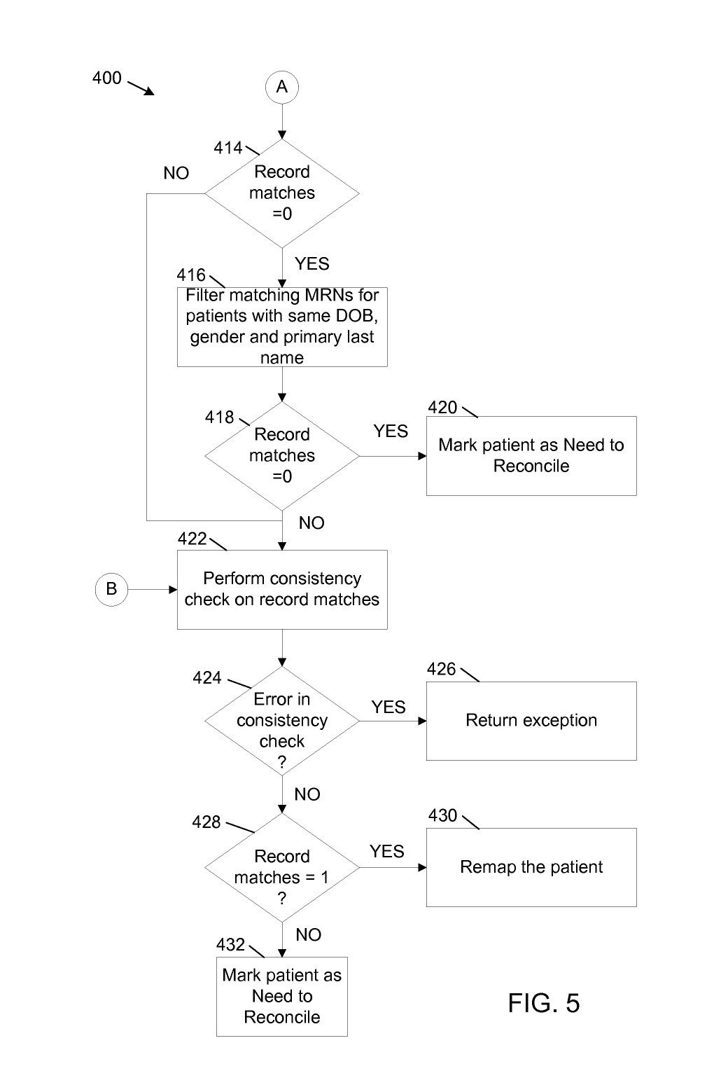

FIG. 4 illustrates an example flowchart of a method 400 for implementing fuzzy logic rules when adding or updating a medical record of a patient in a medical records system. At operation 402, a medical record number (MRN) is obtained for the patient. In a medical environment each patient has a unique MRN that is used to identify the patient. When the patient is an existing patient, the MRN may be obtained from the patient, for example by asking the patient, from a form filled out by the patient, etc. When the patient is new, the medical records system typically generates a MRN for the patient.

At operation 404, a medical records database in the medical records system is searched for the MRN. The object of the search is to determine whether one or more medical records with the same MRN currently exist in the medical records database. Ideally, for a new patient, no matching MRNs should be found and ideally, for an existing patient, only one MRN match should be found. However, as discussed, it is possible for multiple MRNs to have been entered for the same patient and it is possible for the same MRN to have been used for different patients.

At operation 406, a determination is made whether any MRN matches have been found. When it is determined at operation 406 that no MRN matches have been found, at operation 408, a response to the search is returned indicating that no MRN matches have been found. In examples, when no MRN matches are found, the patient can be safely added to the medical records system.

When it is determined at operation 406 that one or more MRN matches have been found, at operation 410, a determination is made as to whether a rule is in place to determine medical record matches based on MRN only. When it is determined at operation 410 that a rule is in place to determine patient matches based on MRN only, control advances to operation 422 where a consistency check is performed on the matching medical records for the patient. A consistency check includes performing one or more matching checks associated with DOB, gender and patient last name to verify that there are no conflicts.

When it is determined at operation 410 that a rule is not in place to determine patient matches based on MRN only, at operation 412 the MRN matches are filtered for patients with the same DOB and gender. In this filtering operation, the DOB and gender of the patient are compared with the DOB and gender in the MRN matches to determine whether matches for DOB and gender are found. When determining matches for DOB and gender, fuzzy logic rules are such that if the DOB or gender fields in the MRN matches are null, then it is assumed that the DOB and gender matches the DOB and gender of the patient.

At operation 414, when it is determined that medical record matches from operation 412 are zero, meaning that for the one or more MRN matches, there are no matches on DOB and gender, at operation 416 the MRN matches are filtered for patients with the same DOB, gender and primary last name.

At operation 414, when it is determined that medical record matches from operation 412 are not zero, meaning that for the one or more MRN matches, there are at least two records that also match on both DOB and gender, control advances to operation 422 where a consistency check is performed on the at least two filtered matches. A consistency check includes performing one or more matching checks associated with DOB, gender and patient last name to verify that there are no conflicts.

At operation 418, when it is determined that medical record matches from operation 416 are zero, meaning that for the one or more MRN matches, there are no matches on DOB, gender and primary last name, at operation 420 the patient is marked as Need to Reconcile. Marking the patient as Need to Reconcile indicates in the medical records system that for this patient there is more than one medical record having the same MRN but no matches on DOB, gender and primary last name. In this case, the MRN matches need to be manually reconciled.

At operation 418, when it is determined that medical record matches from operation 416 do not equal zero, meaning that for the one or more MRN matches, there is at least one medical record for which the DOB, gender and primary last name match that of the patient, at operation 422, a consistency check is performed on the at least one medical record matches for which the DOB, gender and primary last name match that of the patient. A consistency check includes performing one or more matching checks associated with DOB, gender and patient last name to verify that there are no conflicts.

At operation 424, a determination is made as to whether there are any errors in the consistency check. When it is determined at operation 424 that there is at least one error in the consistency check, at operation 426, an exception is returned as a result of the search. The exception indicates that a discrepancy was detected in the MRN records for the patient.

At operation 424 when it is determined that there are no errors in the consistency check, at operation 428 a determination is made as to whether the record matches are equal to 1, meaning that there are two medical records that match the patient. One record match corresponds to two identical medical records for the same patient. When it is determined at operation 428 that the record matches are equal to 1, at operation 430 the patient is remapped. Remapping the patient involves either: (i) removing one of the two identical medical records for the patent from the EMR system 102; or (ii) merging the two medical records to the extent the one or both of the records include additional data not found in the other record. Various techniques for merging can be used.

When it is determined at operation 428 that the number of record matches are not equal to 1, meaning that the number of record matches are greater than one, at operation 432 the patient is marked as Need to Reconcile. In this case there are more than two medical records that have the same MRN and also match for either DOB and gender or DOB, gender and primary last name. For this case, a manual reconciling of these matching medical records is required.

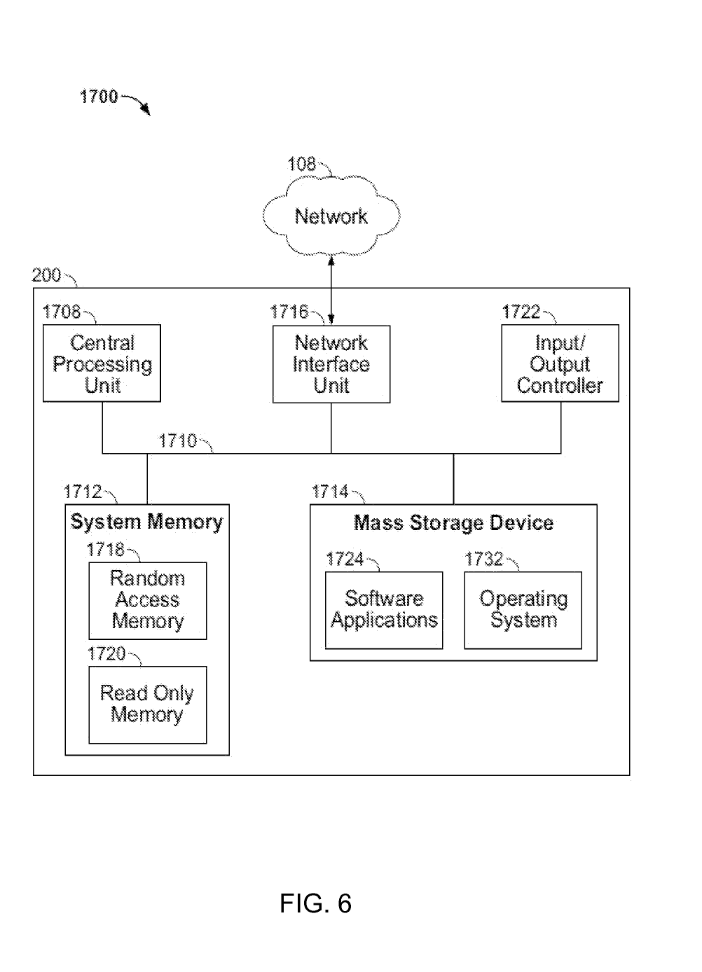

FIG. 6 illustrates example physical components of the physiological monitor device 200. As illustrated in the example of FIG. 6, the physiological monitor device 200 include at least one central processing unit (“CPU”) 1708, a system memory 1712, and a system bus 1710 that couples the system memory 1712 to the CPU 1708. The system memory 1712 includes a random access memory (“RAM”) 1718 and a read-only memory (“ROM”) 1720. A basic input/output system containing the basic routines that help to transfer information between elements within the physiological monitor device 200, such as during startup, is stored in the ROM 1720. The physiological monitor device 200 further includes a mass storage device 1714. The mass storage device 1714 is able to store software instructions and data.

The mass storage device 1714 is connected to the CPU 1708 through a mass storage controller (not shown) connected to the bus 1710. The mass storage device 1714 and its associated computer-readable data storage media provide non-volatile, non-transitory storage for the physiological monitor device 200. Although the description of computer-readable data storage media contained herein refers to a mass storage device, such as a hard disk or CD-ROM drive, it should be appreciated by those skilled in the art that computer-readable data storage media can be any available non-transitory, physical device or article of manufacture from which the physiological monitor device 200 can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the physiological monitor device 200.

According to various embodiments of the invention, the physiological monitor device 200 may operate in a networked environment using logical connections to remote network devices through the network 108, such as a local network, the Internet, or another type of network. The physiological monitor device 200 connects to the network 108 through a network interface unit 1716 connected to the bus 1710. It should be appreciated that the network interface unit 1716 may also be utilized to connect to other types of networks and remote computing systems. The physiological monitor device 200 also includes an input/output controller 1722 for receiving and processing input from a number of other devices, including a keyboard, a mouse, a touch user interface display screen, or another type of input device. Similarly, the input/output controller 1722 may provide output to a touch user interface display screen, a printer, or other type of output device.

As mentioned briefly above, the mass storage device 1714 and the RAM 1718 of the physiological monitor device 200 can store software instructions and data. The software instructions include an operating system 1732 suitable for controlling the operation of the physiological monitor device 200. The mass storage device 1714 and/or the RAM 1718 also store software instructions, that when executed by the CPU 1708, cause the physiological monitor device 200 to provide the functionality of the physiological monitor device 200 discussed in this document. For example, the mass storage device 1714 and/or the RAM 1718 can store software instructions that, when executed by the CPU 1708, cause the physiological monitor device to display the home screen 600 and other screens.

The description of the example physical components used on the physiological monitor device 200 as shown in FIG. 6 also applies to example physical components used in the EMR system 102. Thus, each of the one or more computing devices in the EMR system 102 includes at least one central processing unit (“CPU”), a system memory, and a system bus that couples the system memory to the CPU. The system memory also includes a random access memory (“RAM”), a read-only memory (“ROM”) and a mass storage device that is able to store software instructions and data. In addition, the mass storage device and its associated computer-readable data storage media provide non-volatile, non-transitory storage for each of the one or more computing devices in the EMR system 102.

The various embodiments described above are provided by way of illustration only and should not be construed to limiting. Various modifications and changes that may be made to the embodiments described above without departing from the true spirit and scope of the disclosure.

What is claimed is:

1. A method for matching patients in a list of patients, the method comprising:
comparing, using a computing device, a first medical record to a second medical record using fuzzy logic; and
when the first medical record matches the second medical record based on the comparison using fuzzy logic, remapping the first medical record and the second medical record.

2. The method of claim 1, wherein comparing further comprises determining whether a medical record number from the first medical record matches a medical record number from the second medical record.

3. The method of claim 1, wherein comparing further comprises determining whether a medical record number, a date of birth and a gender from the first medical record matches a medical record number, a date of birth and a gender from the second medical record.

4. The method of claim 1, wherein comparing further comprises determining whether a medical record number, a date of birth, a gender and a patient last name from the first medical record matches a medical record number, a date of birth, a gender and a patient last name from the second medical record.

5. The method of claim 1, wherein comparing further comprises:
determining whether a medical record number from the first medical record is null or empty;
determining whether a medical record number from the second medical record is null or empty; and
when it is determined that the medical record number from the first medical record is null or empty or when it is determined that the medical record number from the second medical record is null or empty, making a determination that the first medical record does not match the second medical record.

6. The method of claim 1, wherein comparing further comprises:
determining whether a date of birth from the first medical record is null or empty;
determining whether a date of birth from the second medical record is null or empty; and
when it is determined that the date of birth from the first medical record is null or empty or when it is determined that the date of birth from the second medical record is null or empty, making a determination that the date of birth from the first medical record matches the date of birth from the second medical record.

7. The method of claim 1, wherein comparing further comprises:
determining whether a gender from the first medical record is null or unknown gender;
determining whether a gender from the second medical record is null or unknown gender; and
when it is determined that the gender from the first medical record is null or unknown gender or when it is determined that the gender from the second medical record is null or unknown gender, making a determination that the gender from the first medical record matches the gender from the second medical record.

8. The method of claim 1, wherein comparing further comprises:
determining whether a patient last name from the first medical record is null or empty;
determining whether a patient last name from the second medical record is null or empty; and
when it is determined that the patient last name from the first medical record is null or empty or when it is determined that the patient last name from the second medical record is null or empty, making a determination that the patient last name from the first medical record matches the patient last name from the second medical record.

9. The method of claim 1, wherein when the first medical record matches the second medical record based on the comparison using fuzzy logic further comprises:
determining that a medical record number from the first medical record matches a medical record number from the second medical record.

10. The method of claim 1, wherein when the first medical record matches the second medical record based on the comparison using fuzzy logic further comprises:
determining that a medical record number from the first medical record matches a medical record number from the second medical record;
determining that a date of birth from the first medical record matches a date of birth from the second medical record; and
determining that a gender from the first medical record matches a gender from the second medical record.

11. The method of claim 1, wherein when the first medical record matches the second medical record based on the comparison using fuzzy logic further comprises:
determining that a medical record number from the first medical record matches a medical record number from the second medical record;
determining that a date of birth from the first medical record matches a date of birth from the second medical record;
determining that a gender from the first medical record matches a gender from the second medical record; and
determining that a patient last name from the first medical record matches a patient last name from the second medical record.

12. The method of claim 1, wherein remapping the first medical record with the second medical record further comprises:
performing a consistency check between the first medical record and the second medical record, the consistency check comprising:
verifying that a medical record number from the first medical record matches a medical record number from the second medical record;
verifying that a date of birth from the first medical record matches a date of birth from the second medical record or verifying that the date of birth from the first medical record or from the second medical record is null;
verifying that a gender from the first medical record matches a gender from the second medical record or verifying that the gender from the first medical record or from the second medical record is null; and
verifying that a patient last name from the first medical record matches a patient last name from the second medical record or verifying that the patient last name from the first medical record or from the second medical record is null.

13. The method of claim 12, further comprising:
determining whether any errors occurred during the consistency check; and
when it is determined that no errors occurred during the consistency check, removing either the first medical record or the second medical record from a medical records database.

14. A method for matching patients in a list of patients, the method comprising:
comparing, using a computing device, a first medical record to a second medical record using fuzzy logic, the comparing of the first medical record to the second medical record comprising:
making at least one of a first determination, a second determination and a third determination,
the first determination comprising determining whether a medical record number from the first medical record matches a medical record number from the second medical record,
the second determination comprising determining whether the medical record number, a date of birth and a gender from the first medical record matches the medical record number, the date of birth and the gender from the second medical record, and
the third determination comprising determining whether the medical record number, the date of birth, the gender and a patient last name from the first medical record matches the medical record number, the date of birth, the gender and the patient last name from the second medical record;
determining whether the medical record number from the first medical record is null or empty;
determining whether the medical record number from the second medical record is null or empty;
determining whether the date of birth from the first medical record is null or empty;
determining whether the date of birth from the second medical record is null or empty;
determining whether the gender from the first medical record is null or unknown gender;
determining whether the gender from the second medical record is null or unknown gender;
determining whether the patient last name from the first medical record is null or empty;
determining whether the patient last name from the second medical record is null or empty;
when it is determined that the medical record number from the first medical record is null or empty or when it is determined that the medical record number from the second medical record is null or empty, making a determination that the first medical record does not match the second medical record;
when it is determined that the date of birth from the first medical record is null or empty or when it is determined that the date of birth from the second medical record is null or empty, making a determination that the date of birth from the first medical record matches the date of birth from the second medical record;
when it is determined that the gender from the first medical record is null or unknown gender or when it is determined that the gender from the second medical record is null or unknown gender, making a determination that the gender from the first medical record matches the gender from the second medical record; and
when it is determined that the patient last name from the first medical record is null or empty or when it is determined that the patient last name from the second medical record is null or empty, making a determination that the patient last name from the first medical record matches the patient last name from the second medical record; and
when the first medical record matches the second medical record based on the comparison using fuzzy logic, merging the first medical record with the second medical record,
the determination of when the first medical record matches the second medical record comprising at least one of a fourth determination, a fifth determination and a sixth determination,
the fourth determination comprising determining that the medical record number from the first medical record matches the medical record number from the second medical record,
the fifth determination comprising:
determining that the medical record number from the first medical record matches the medical record number from the second medical record;
determining that the date of birth from the first medical record matches the date of birth from the second medical record; and
determining that the gender from the first medical record matches the gender from the second medical record,
the sixth determination comprising:
determining that the medical record number from the first medical record matches the medical record number from the second medical record;
determining that the date of birth from the first medical record matches the date of birth from the second medical record;
determining that the gender from the first medical record matches the gender from the second medical record; and
determining that the patient last name from the first medical record matches the patient last name from the second medical record,
the merging of the first medical record with the second medical record comprising:
performing a consistency check between the first medical record and the second medical record, the consistency check comprising making at least one of a first verification, a second verification, a third verification and a fourth verification,
the first verification comprising verifying that the medical record number from the first medical record matches the medical record number from the second medical record,
the second verification comprising verifying that the date of birth from the first medical record matches the date of birth from the second medical record or verifying that the date of birth from the first medical record or from the second medical record is null,
the third verification comprising verifying that the gender from the first medical record matches the gender from the second medical record or verifying that the gender from the first medical record or from the second medical record is null, and
the fourth verification comprising verifying that the patient last name from the first medical record matches the patient last name from the second medical record or verifying that the patient last name from the first medical record or from the second medical record is null;
determining whether any errors occurred during the consistency check; and
when it is determined that no errors occurred during the consistency check, removing either the first medical record or the second medical record from a medical records database.

15. A computer-readable storage medium comprising instructions that, when executed by a computing device, cause the computing device to:
compare a first medical record to a second medical record using fuzzy logic; and
when the first medical record matches the second medical record based on the comparison using fuzzy logic, merge the first medical record with the second medical record.

16. The computer-readable storage medium of claim 15, wherein comparing further comprises determining whether a medical record number from the first medical record matches a medical record number from the second medical record.

17. The computer-readable storage medium of claim 15, wherein comparing further comprises determining whether a medical record number, a date of birth and a gender from the first medical record matches a medical record number, a date of birth and a gender from the second medical record.

18. The computer-readable storage medium of claim 15, wherein comparing further comprises determining whether a medical record number, a date of birth, a gender and a patient last name from the first medical record matches a medical record number, a date of birth, a gender and a patient last name from the second medical record.

19. The computer-readable storage medium of claim 15, wherein merging the first medical record with the second medical record further comprises:
performing a consistency check between the first medical record and the second medical record, the consistency check comprising:
verifying that a medical record number from the first medical record matches a medical record number from the second medical record;
verifying that a date of birth from the first medical record matches a date of birth from the second medical record or verify that the date of birth from the first medical record or from the second medical record is null;
verifying that a gender from the first medical record matches a gender from the second medical record or verify that the gender from the first medical record or from the second medical record is null; and
verifying that a patient last name from the first medical record matches a patient last name from the second medical record or verify that the patient last name from the first medical record or from the second medical record is null.

20. The computer-readable storage medium of claim 19, further comprising:
determining whether any errors occurred during the consistency check; and
when it is determined that no errors occurred during the consistency check, removing either the first medical record or the second medical record from a medical records database.
